(19) United States
(12) Patent Application Publication
(10) Pub. No.: US 2008/0219850 A1
(43) Pub. Date: Sep. 11, 2008

(54) Wind Turbine

(76) Inventors: Arthur Benjamin O'Connor, Victoria (AU); Clive Filleul Grainger, Victoria (AU)

Correspondence Address: Pearl Cohen Zedek Latzer, LLP, 1500 Broadway, 12th Floor, New York, NY, 10036, US

(21) Appl. No.: 12/089,229

(22) PCT Filed: Oct. 4, 2006
(86) PCT No.: PCT/AU2006/001452

§ 371 Date: May 14, 2008

(30) Foreign Application Priority Data
Oct. 4, 2005 (AU) 2005905474

(51) Int. Cl. F03D 1/06

(52) U.S. Cl. 416/223 R

(57) ABSTRACT

A method of designing a rotor for a horizontal axis wind turbine. The method combines an actuator disk analysis with a cascade fan design method to define the blade characteristics, including the shape and size of the blades, such that the maximum amount of energy is extracted from the air at the lowest rotational speed. A method of manufacturing a wind turbine and a turbine designed in accordance with the method are also disclosed.

### FIELD OF THE INVENTION

The present invention relates generally to wind turbines. In particular, the invention concerns small, low speed, horizontal axis wind turbines.

### BACKGROUND OF THE INVENTION

With concerns about global warming growing, there has been increasing interest in the generation of electricity by harnessing the power of the wind. Wind turbines developed in recent decades for this purpose, as opposed to being for agricultural purposes, are generally very large, complex and expensive to manufacture. Modern horizontal axis wind turbines of the “high-speed” type, as used in large scale power generation, typically include two or three propeller-style blades with a diameter of 100 meters or more. The tip speed ratio of such turbines is often in the region of 7.0.

In contrast, small “low-speed” turbines have also been developed and these usually include a larger number of smaller blades. One example of such a turbine was described by Cobden in U.S. Pat. No. 4,415,306 and Australian Patent No 563265 (hereinafter referred to as the Cobden turbine). The Cobden turbine was far less complex and far less expensive to manufacture than a typical high speed power generation turbine, but it was also far less efficient.

The theoretical maximum power output available from a wind turbine is given by

Power_{MAX}=C_{P}ρAV_{A}³ (a)

where the coefficient of performance is

C_{P}= 16/27 or approximately 0.59.

High speed operation is desirable to produce maximum power, i.e. the coefficient of performance is close to the theoretical maximum. However, in high wind speeds, complex speed limiting mechanisms must be employed to prevent the turbine self destructing. Such mechanisms may turn, or furl, all or part of the blades so as to reduce energy capture from the wind.

On the other hand, the Cobden turbine ran very slowly, with a tip speed ratio of only about 0.6. It was very quiet in operation, and of simple construction with fixed blades. It did not need complex control mechanisms to prevent it over speeding but its performance was limited.

An objective of the present invention is therefore to provide a small, low speed wind turbine which is efficient, inexpensive and robust.

In this context, the term “small” should be understood to mean a turbine rotor of less than about 10 meters in diameter. The term “low speed” means a rotational speed of the rotor of less than about 400 revolutions per minute and the term “efficient” means that the power output of the turbine should approach the theoretical maximum.

There are several known methods of designing wind turbines. Two of these methods, briefly described here, are detailed by Wilson [1995].

1. Actuator disk theory. The simplest model of a horizontal axis wind turbine (HAWT) is one in which the turbine rotor is replaced by an actuator disk which removes energy from the wind. As the wind strikes the actuator disk on the upwind side, the pressure rises there, and the wind is deflected away from the disk, causing a large wake downstream of the disk. Actuator disk theory relates the pressure drop across the disk to the change in wake size and the energy which can be extracted from the wind. Rankine [1865], R. Froude [1889] and W. Froude [1878] were the earliest developers of actuator disk theory, particularly with respect to the design of ship propellers. Their theory did not include the effect of wake rotation, which was added later by Joukowski [1918]. Then Glauert [1935] developed a simple actuator disk analysis for an optimum HAWT rotor. Actuator disk theory yields equation (a) above for turbine maximum power, however, actuator disk theory does not yield the rotor geometry without further design theory. Wilson [1995] shows one way to do this using blade element theory, and his method is somewhat similar to that used in the present invention.

2. Strip theory, or modified blade-element theory. As stated by Wilson,
“Blade-element theory was originated by Froude [1878] and later developed further by Drzewiecki [1892]. The approach of blade-element theory is opposite that of momentum theory since it is concerned with the forces produced by the blades as a result of the motion of the fluid. Modern rotor theory has developed from the concept of free vortices being shed from rotating blades. These vortices define a slipstream and generate induced velocities . . . . It has been found that strip-theory approaches are adequate for the analysis of wind machine performance.”

### SUMMARY OF THE INVENTION

One aspect of the present invention provides a method of designing a horizontal axis wind turbine. This method combines an actuator disk analysis with a cascade fan design method to define the blade characteristics, including the shape and size of the blades, such that the maximum amount of energy may be extracted from the air at the lowest rotational speed.

Another aspect of the invention provides a rotor for a horizontal axis wind turbine. The rotor has a hub and a plurality of elongate blades extending radially from the hub. The blades are shaped such that in operation, at any selected radial position along the length of the blades, the ratio of air whirl velocity C_{U} leaving the blades in the direction of blade rotation divided by axial wind speed upstream of the rotor V_{A} is given by:

$$\frac{{C}_{U}}{{V}_{A}} = \frac{4}{9 λ}$$

wherein λ is the local speed ratio at the selected radial position and is given by

$$λ = \frac{U}{{V}_{A}}$$

wherein U is the circumferential blade speed at the selected radial position.

In a preferred embodiment, the blade chord c, at the selected radial position, is given by:

c=s×S

wherein

s is the spacing of the blades which is given by

$$s = \frac{2 π r}{Z}$$

wherein r is the radius at the selected radial position and Z is the number of blades

and wherein

S is solidity which is given by:

$$S = \frac{2 cos ( {β}_{m} ) ( {C}_{U} / {V}_{A} )}{( 2 / 3 ) ( {C}_{L} - {C}_{D} tan ( {β}_{m} ) )}$$

wherein

βₘ is a mean angle of air flow relative to the blades and is given by

tan(βₘ)=0.5(tan(β₁)+tan(β₂))

wherein

β₁ is an angle between upstream air flowing relative to the blades and the turbine axis of rotation, and is given by

$$tan ( {β}_{1} ) = \frac{λ}{2 / 3}$$

and β₂ is an angle between downstream air flowing relative to the blades and the turbine axis of rotation, and is given by

$$tan ( {β}_{2} ) = \frac{3 ( λ + {C}_{U} / {V}_{A} )}{2}$$

and wherein C_{L} is a coefficient of lift and is given by

C_{L}=C_{Lh}+f×(C_{Lt}−C_{Lh})

and C_{D} is a coefficient of drag and is given by

C_{D}=C_{Dh}+f×(C_{Dt}−C_{Dh})

wherein

C_{Lh} is a selected blade lift coefficient at the hub

C_{Lt} is a selected blade lift coefficient at the blade tips

C_{Dh} is a selected blade drag coefficient at the hub

C_{Dt} is a selected blade drag coefficient at the blade tips

f is a radius fraction at the selected radial position and is equal to 0 at the hub and 1 at the tip of the blade.

Each blade is preferably a cambered plate aerofoil and the camber angle θ of the aerofoil, at the selected radial position, is given by:

$$θ = \frac{( {C}_{L} - {A}_{1} \times i - {C}_{1} )}{{B}_{1}}$$

wherein A₁, B₁ and C₁ are constants as follows

A₁=0.0089 deg⁻¹

B₁=0.0191 deg⁻¹

C₁=0.0562

and i is the angle of incidence of air into the blades and is given by

i=iₕ+f×(iₜ−iₕ)

wherein

iₕ is a selected angle of incidence at the blade hub

iₜ is a selected angle of incidence at the blade tip.

An advantage of using simple cambered plate aerofoils is that they are cheap to produce, thereby enabling the manufacture of an inexpensive turbine of simple and robust construction. Advantageously, the camber angle θ of the aerofoil varies from 10-15 degrees at the tip of the blades to 25-30 degrees at the hub.

The stagger angle ξ, of the blade chord from the axis of rotation of the turbine, at the selected radial position, is preferably given by:

ξ=β₁+i.

Advantageously, the stagger angle ξ varies from approximately 60 degrees at the hub to approximately 80 degrees at the tip of the blades.

In a preferred embodiment the hub has a relatively large diameter. Preferably, the hub has a diameter of between 40% and 50% of the diameter of the rotor, measured at tips of the blades, and is solid so as to prevent air passing through the hub. The hub then serves to force more air through the blades, thus extracting more energy from the wind. Advantageously, the hub has a diameter of about 45% of the diameter of the rotor.

A further aspect of the invention provides a method of defining blade characteristics of a horizontal axis wind turbine, the turbine having a rotor with a hub and a plurality of elongate blades extending radially from the hub. The method includes the steps of:

a) selecting a value for at least one of the following design parameters:

| | |
|---|---|
| Number of blades | Z |
| Hub diameter | Dₕ |
| Blade tip diameter | Dₜ |
| Tip Speed ratio | λₜ |
| Far upstream windspeed | V_{A} |

b) selecting a radial position along the length of the blades;
c) computing a local speed ratio λ at the selected radial position based on the selected value(s) of the design parameter(s);
d) computing a ratio of air whirl velocity C_{U} leaving the blades in the direction of blade rotation divided by axial wind speed upstream of the rotor V_{A} using:

$$\frac{{C}_{U}}{{V}_{A}} = \frac{4}{9 λ}$$

e) computing a blade chord, c, camber angle, θ, and stagger angle, ξ, of the blade chord from the turbine axis of rotation, at the selected radial position, as a function of the ratio C_{U}/V_{A}; and
f) selecting at least one alternative radial position and repeating steps (c) to (e) to compute the blade chord, c, camber angle, θ, and stagger angle, ξ, at the alternative radial position in order to define the blade characteristics along the length of the blades.

Preferably the method includes the further step of selecting an alternative value for at least one of the design parameters and repeating steps (b) to (f) so as to optimise the blade characteristics to maximise energy extraction from the air flow at the lowest rotational speed of the rotor.

A further, more specific, aspect of the invention provides a method of defining blade characteristics of a horizontal axis wind turbine, the turbine having a rotor with a hub and a plurality of elongate blades extending radially from the hub. The method includes the steps of:

a) selecting a value for at least one of the following design parameters:

| | |
|---|---|
| Number of blades | Z |
| Hub diameter | Dₕ |
| Blade tip diameter | Dₜ |
| Tip Speed ratio | λₜ |
| Far upstream windspeed | V_{A} |
| Blade lift coefficient at the blade hub | C_{Lh} |
| Blade lift coefficient at the blade tip | C_{Lt} |
| Blade drag coefficient at the blade hub | C_{Dh} |
| Blade drag coefficient at the blade tip | C_{Dt} |
| Angle of incidence at the blade hub | iₕ |
| Angle of incidence at the blade tip | iₜ |

b) computing the blade rotational speed N based on λₜ, V_{A} and Dₜ
c) computing a radius fraction, f, representing a selected radial position along the length of the blades wherein f equals 0 at the hub and 1 at the blade tip;
d) computing the radius, r, at the selected radial position as a function of f, Dₜ and Dₕ
e) computing the spacing of the blades, s, based on Z
f) computing the blade speed, U, at the selected radial position, based on N
g) computing the local speed ratio, λ, based on U and V_{A}
h) computing a non-dimensional air whirl velocity ratio, C_{U}/V_{A}, leaving the rotor in the direction of blade rotation using

$$\frac{{C}_{U}}{{V}_{A}} = \frac{4}{9 λ}$$

i) computing an angle between upstream air flowing relative to the blade and the turbine axis of rotation, β₁
j) computing an angle between downstream air flowing relative to the blade and the turbine axis of rotation, β₂
k) computing the mean angle of air flow relative to the blade, βₘ, as a function of β₁ and β₂
l) computing a coefficient of lift, C_{L}, as a function of f, C_{Lh} and C_{Lt}
m) computing a coefficient of drag, C_{D}, as a function of f, C_{Dh} and C_{Dt}
n) computing the required solidity, S, as a function of βₘ, C_{U}/V_{A}, C_{L} and C_{D}
o) computing the required blade chord, c, based on S and s
p) computing an angle of incidence, i, of the air onto the blades based on f, iₕ and iₜ
q) computing a camber angle, θ, based on C_{L}
r) computing a stagger angle, ξ, of the blade chord from the turbine axis, based on β₁ and i;
s) selecting at least one alternative radial position and repeating steps (c) to (r) to compute the blade chord, c, camber angle, θ, and stagger angle, ξ, at the alternative radial position in order to define the blade characteristics along the length of the blades

Once again, this method preferably includes the further step of selecting an alternative value for at least one of the design parameters and repeating steps (b) to (s) so as to optimise the blade characteristics to maximise energy extraction from the air flow at the lowest rotational speed of the rotor.

A further, even more specific, aspect of the invention provides a method of defining blade characteristics of a horizontal axis wind turbine, the turbine having a rotor with a hub and a plurality of elongate blades extending radially from the hub, wherein each of the blades is a cambered plate aerofoil having a circular arc cross section. The method includes the steps of:

a) selecting a value for at least one of the following design parameters:

| | |
|---|---|
| Number of blades | Z |
| Hub diameter | Dₕ |
| Blade tip diameter | Dₜ |
| Tip Speed ratio | λₜ |
| Far upstream windspeed | V_{A} |
| Blade lift coefficient at the blade hub | C_{Lh} |
| Blade lift coefficient at the blade tip | C_{Lt} |
| Blade drag coefficient at the blade hub | C_{Dh} |
| Blade drag coefficient at the blade tip | C_{Dt} |
| Angle of incidence at the blade hub | iₕ |
| Angle of incidence at the blade tip | iₜ |

b) computing the blade rotational speed N using

$$N = \frac{60 {λ}_{t} {V}_{A}}{π {D}_{t}}$$

c) computing a radius fraction, f, representing a selected radial position along the length of the blades wherein f equals 0 at the hub and 1 at the blade tip;
d) computing the radius, r, at the selected radial position using

r=Rₕ+f×(Rₜ−Rₕ)
wherein
Rₕ is the radius of the rotor at the hub, and
Rₜ is the radius of the rotor at the blade tip;
   e) computing the spacing of the blades, s, using

$$s = \frac{2 π r}{Z}$$

f) computing the blade speed, U, at the selected radial position using

$$U = \frac{2 π r N}{60}$$

g) computing the local speed ratio, λ, using

$$λ = \frac{U}{{V}_{A}}$$

h) computing a non-dimensional air whirl velocity ratio, C_{U}/V_{A}, leaving the rotor in the direction of blade rotation using

$$\frac{{C}_{U}}{{V}_{A}} = \frac{4}{9 λ}$$

i) computing an angle between upstream air flowing relative to the blade and the turbine axis of rotation, β₁, from

$$tan ( {β}_{1} ) = \frac{λ}{2 / 3}$$

j) computing an angle between downstream air flowing relative to the blade and the turbine axis of rotation, β₂, from

$$tan ( {β}_{2} ) = \frac{3 ( λ + {C}_{U} / {V}_{A} )}{2}$$

k) computing the mean angle of air flow relative to the blade, βₘ, from

tan(βₘ)=0.5(tan(β₁)+tan(β₂))

l) computing a coefficient of lift, C_{L}, using

C_{L}=C_{Lh}+f×(C_{Lt}−C_{Lh})

m) computing a coefficient of drag, C_{D}, using

C_{D}=C_{Dh}+f×(C_{Dt}−C_{Dh})

n) computing the required solidity, S, from

$$S = \frac{2 cos ( {β}_{m} ) ( {C}_{U} / {V}_{A} )}{( 2 / 3 ) ( {C}_{L} - {C}_{D} tan ( {β}_{m} ) )}$$

o) computing the required blade chord, c, from

c=s×S

p) computing an angle of incidence, i, of the air onto the blades using

i=iₕ+f×(iₜ−iₕ)

q) computing a camber angle, θ, of circular arc blades using

$$θ = \frac{( {C}_{L} - {A}_{1} \times i - {C}_{1} )}{{B}_{1}}$$

wherein A₁, B₁ and C₁ are constants as follows
A₁=0.0089 deg⁻¹
B₁=0.0191 deg⁻¹
C₁=0.0562
   r) computing a stagger angle, ξ, of the blade chord from the turbine axis, using

ξ=β₁+i

s) selecting at least one alternative radial position and repeating steps (c) to (r) to compute the blade chord, c, camber angle, θ, and stagger angle, ξ, at the alternative radial position in order to define the blade characteristics along the length of the blades.

Again, this method preferably includes the further step of selecting an alternative value for at least one of the design parameters and repeating steps (b) to (s) so as to optimise the blade characteristics to maximise energy extraction from the air flow at the lowest rotational speed of the rotor.

A still further aspect of the invention provides a method of manufacturing a rotor for a horizontal axis wind turbine, the rotor having a hub and a plurality of elongate blades extending radially from the hub. The method includes the steps of:

defining the blade characteristics in accordance with one of the methods described above; and

manufacturing a rotor including blades with the defined characteristics.

A still further aspect of the invention provides a rotor for a horizontal axis wind turbine. The rotor includes blades having characteristics defined in accordance with one of the methods described above.

A still further aspect of the invention provides a horizontal axis wind turbine including a rotor with a hub and a plurality of elongate blades extending radially from the hub. The blades have characteristics defined in accordance with one of the methods described above.

### BRIEF DESCRIPTION OF THE DRAWINGS

A preferred embodiment of the invention will now be described with reference to the accompanying drawings. It is to be appreciated that this embodiment is given by way of illustration only and the invention is not limited by this illustration. In the drawings:

FIG. 1 shows a perspective view of a wind turbine in accordance with a preferred embodiment of the present invention;

FIG. 2 depicts a representation of velocity vectors in a tangential plane for the rotor shown in FIG. 1;

FIG. 3 shows a sample of wind turbine design calculations in accordance with a preferred embodiment of the method of the invention; and

FIG. 4 shows the measured performance of a model turbine produced in accordance with the preferred embodiment of the invention.

### DETAILED DESCRIPTION OF A PREFERRED EMBODIMENT

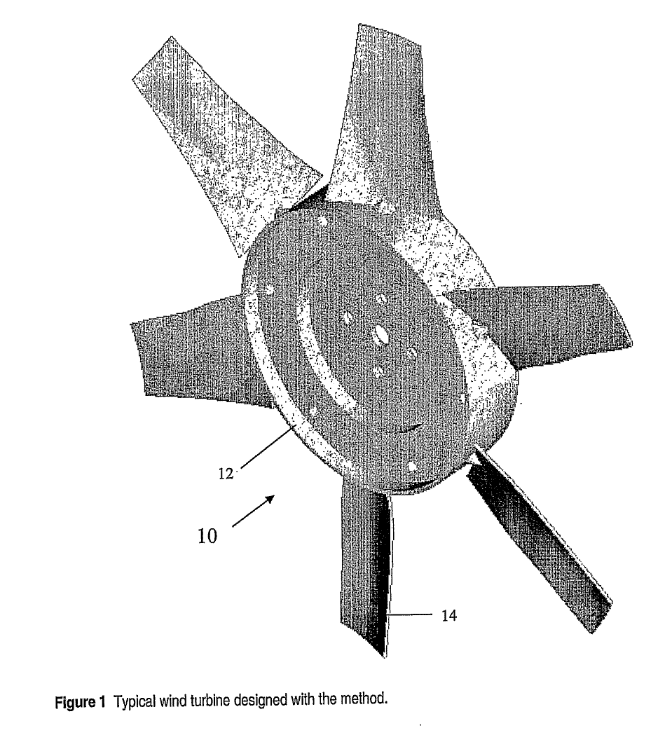

Referring to the drawings, FIG. 1 shows a rotor 10 for a horizontal axis wind turbine which has been designed in accordance with a preferred embodiment of the present invention. The rotor 10 includes a hub 12 and a plurality of blades 14 extending radially from the hub 12. The blades 14 are shaped such that in operation, at any selected radial position along the length of the blades, the ratio of air whirl velocity C_{U} leaving the blades in the direction of blade rotation divided by axial wind speed upstream of the rotor V_{A} is given by:

$$\frac{{C}_{U}}{{V}_{A}} = \frac{4}{9 λ}$$

wherein λ is the local speed ratio at the selected radial position and is given by

$$λ = \frac{U}{{V}_{A}}$$

wherein U is the circumferential blade speed at the selected radial position.

The following is a detailed description of a process for defining the shape of the blades to meet this requirement. This preferred form of the process, which is given by way of illustration only, is specifically directed to the design of small, slow speed, efficient wind turbines. Variations of this process will become apparent to a person skilled in the art of wind turbine design.

The design process is an iterative process. To facilitate the process, the inventors have found it convenient to encode the design equations (as explained below) within an Excel™ spreadsheet so as to enable automatic computation of the complete design of the rotor blades.

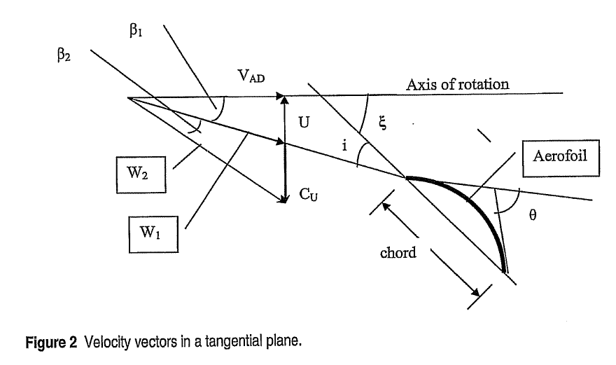

FIG. 2 depicts a representation of velocity vectors in a tangential plane for a horizontal axis wind turbine rotor. The shape of each blade is defined by its stagger angle ξ, blade chord c and blade camber angle θ for each position, or height, along the length of the blade.

A number of design parameters, as listed below, are chosen. The whole design of the rotor blades is then automatically computed by the spreadsheet, and inspected to see if it meets the requirements. These requirements are for reasonable blade stagger, blade chord and blade camber at each blade position from hub to tip. The design parameters are modified until the requirements are met. Reasonable blade stagger is defined by the inventors to mean approximately 60 degrees at the hub to approximately 80 degrees at the tip. Reasonable blade chord is assessed by considering that the blades may be too small to be stiff, or so large and heavy that the cost will be great and the centrifugal forces generated by the rotating blades will be too great. Reasonable blade camber is in the region of 10-15 degrees at the tip, to 25-30 degrees at the hub.

### Design Parameters

| DESIGN PARAMETER | SYMBOL |
|---|---|
| Number of blades | Z |
| Hub diameter | Dₕ |
| Blade tip diameter | Dₜ |
| Tip Speed ratio | λₜ |
| Far upstream windspeed | V_{A} |
| Blade lift coefficient at the blade hub | C_{Lh} |
| Blade lift coefficient at the blade tip | C_{Lt} |
| Blade drag coefficient at the blade hub | C_{Dh} |
| Blade drag coefficient at the blade tip | C_{Dt} |
| Angle of incidence at the blade hub | iₕ |
| Angle of incidence at the blade tip | iₜ |

### Design Constants

For simple cambered plate aerofoils:

A₁=0.0089 deg⁻¹ B₁=0.0191 deg⁻¹ C₁=0.0562

in C_{L}=A₁×I+B₁×θ+C₁ (1)

### Design Equations and Procedure

1. Blade rotational speed, N, is first calculated using

$$N = \frac{60 {λ}_{t} {V}_{A}}{π {D}_{t}} \qquad ( 2 )$$

2. A radius fraction, f, is chosen, in the range 0 (at the hub) to 1 (at the tip). The radius is then given by

r=Rₕ+f×(Rₜ−Rₕ) (3)

3. The spacing of the blades, s, is then calculated using

$$s = \frac{2 π r}{Z} \qquad ( 4 )$$

4. The blade speed, U, at the selected radius is then given by

$$U = \frac{2 π r N}{60} \qquad ( 5 )$$

5. The local speed ratio, λ, is given by

$$λ = \frac{U}{{V}_{A}} \qquad ( 6 )$$

6. The non-dimensional whirl velocity, C_{U}/V_{A}, leaving the rotor is given by

$$\frac{{C}_{U}}{{V}_{A}} = \frac{4}{9 λ} \qquad ( 7 )$$

7. The angle between the upstream air flowing relative to the blade and the turbine axis of rotation, β₁, is given from

$$tan ( {β}_{1} ) = \frac{λ}{2 / 3} \qquad ( 8 )$$

8. The angle between the downstream air flowing relative to the blade and the rotor axis of rotation, β₂, is given from

$$tan ( {β}_{2} ) = \frac{3 ( λ + {C}_{U} / {V}_{A} )}{2} \qquad ( 9 )$$

9. The mean angle of air flow relative to the blade, βₘ, is given from

tan(βₘ)=0.5(tan(β₁)+tan(β₂)) (10)

10. The selected coefficient of lift, C_{L}, is given by

C_{L}=C_{Lh}+f×(C_{Lt}−C_{Lh}) (11)

11. The selected coefficient of drag, C_{D}, is given by

C_{D}=C_{Dh}+f×(C_{Dt}−C_{Dh}) (12)

12. The required solidity, S, is then computed from

$$S = \frac{2 cos ( {β}_{m} ) ( {C}_{U} / {V}_{A} )}{( 2 / 3 ) ( {C}_{L} - {C}_{D} tan ( {β}_{m} ) )} \qquad ( 13 )$$

13. The required blade chord, c, is then computed from

c=s×S (14)

14. The incidence, i, of the air onto the blades is given by

i=iₕ+f×(iₜ−iₕ) (15)

15. The camber angle, θ, of the circular arc blades is given by

$$θ = \frac{( {C}_{L} - {A}_{1} \times i - {C}_{1} )}{{B}_{1}} \qquad ( 16 )$$

16. The stagger angle, ξ, of the blade chord from the turbine axis, is given by

ξ=β₁+i (17)

17. The velocity of the air relative to the blades, W, is given by

$$W = ( 2 / 3 ) ( \frac{{V}_{A}}{cos ( {β}_{m} )} ) \qquad ( 18 )$$

18. The blade Reynolds number, Re, is given by

$$Re = \frac{W \times c}{v} \qquad ( 19 )$$

19. The radius of the blade circular arc, r_{bc}, is given by

$${r}_{bc} = \frac{0.5 \times c}{sin ( 0.5 \times θ )} \qquad ( 20 )$$

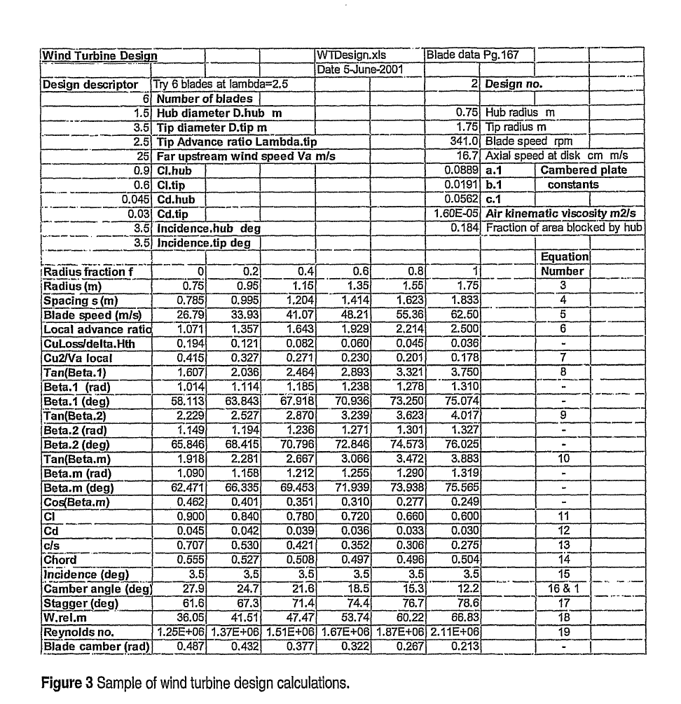

FIG. 3 shows a spreadsheet giving an example of the design parameters and typical calculations involved in the preferred form of the design process.

The feature of the foregoing description that embodies the essence of the invention is the following design analysis.

From actuator disk theory (axial momentum analysis), at the point of maximum turbine efficiency,

V_{AD}=⅔V_{A} (21)

and consequently the static pressure drop across the disk is

Δp= 4/9ρV_{A}² (22)

Now, the total pressure drop across the disk, ΔP, is given by

ΔP=p₁+0.5ρc₁²−p₂−0.5ρc₂²

so that substituting for static pressure drop, Δp, and absolute velocities c₁ and c₂, gives

ΔP=Δp+0.5ρ(V_{AD}²−(V_{AD}²+C_{U}²))

i.e.

ΔP=Δp−0.5ρC_{U}² (23)

The present inventors have realised that it is possible to assume that the whirl velocity, C_{U}, leaving the disk is small compared with V_{A} i.e.

C_{U}²<<V_{A}²

which permits equation (23) to be developed into an equation for the total head drop across the disk, ΔH, as follows

$$Δ P = ρ g Δ H = Δ p = 4 / 9 ρ {V}_{A}^{2} \\ so that \\ Δ H = 4 / 9 \frac{{V}_{A}^{2}}{g} \qquad ( 24 )$$

Finally, using the standard Euler equation for turbo-machinery,

gΔH=C_{U}U (25)

and substituting for ΔH from equation (24) and re-arranging leads to equation (7) viz.

$$\frac{{C}_{U}}{{V}_{A}} = 4 / 9 \frac{{V}_{A}}{U} = \frac{4}{9 λ} \qquad ( 26 )$$

This then leads to equation (13) via the standard equation for the performance of a turbine cascade

$${C}_{L} = 2 s / c \frac{{C}_{U}}{{V}_{A D}} cos ( {β}_{m} ) + {C}_{D} tan ( {β}_{m} ) \qquad ( 27 )$$

The aim is to extract the maximum amount of energy from the wind. This energy comprises a static pressure component and a velocity component. The velocity component of airflow leaving the rotor disk comprises an axial component V_{AD}, in the direction of the rotor axis, and a whirl component C_{U}, in the direction of motion of the blades.

As described above, from actuator disk theory it was found that maximum turbine efficiency requires the axial air velocity V_{AD} at the rotor disk to drop to two thirds of the axial velocity V_{A} far upstream. This is equation 21. Actuator disk theory also determines that the point of maximum turbine efficiency is where the static pressure drop ΔP across the disk is defined by the relationship in equation 22.

The whirl component C_{U} arises from the change in direction of the air as it passes through the rotor disk. When the air hits a blade, the blade is pushed in one direction and the air is pushed in the opposite direction. Accordingly, after the air passes through the rotor disk, it is whirling in a direction opposite to the direction of blade rotation. The energy in this whirling airflow is lost. It is therefore desirable to keep the whirl velocity component C_{U} at a minimum in order to extract the maximum amount of velocity energy from the wind.

The present inventors have recognised that whilst it is important for the whirl component C_{U} to be as small as possible, it is more important for it to be small compared to the axial wind speed V_{AD} and V_{A}, because the wind speed varies. This ratio is non-dimensional with respect to the variable axial wind speed. Also, if C_{U} is smaller than V_{A} then C_{U}² is very much smaller than V_{A}². This means that the second term in equation 23 becomes insignificant relative to the first term in that equation, and can therefore be ignored.

In effect, the inventors have recognised that, for the purposes of calculating the blade characteristics, if you want the whirl velocity C_{U} to be small compared to the axial velocity V_{A}, you can assume it is small. This simplifies the subsequent equations for calculation of the shape and size of the blades. With this assumption, the turbine produced in accordance with the inventive design process is characterised by blades shaped to meet the relationship defined in equation 26 (which is also equation 7).

There are two conflicting requirements and hence a trade off involved. On the one hand, the whirl velocity C_{U} should be as small as possible compared to the axial velocity V_{A} (and V_{AD}) to extract the maximum amount of energy from the velocity component. This requires the blade speed to be as high as possible, because the faster the blades are moving, the less the air turns as it passes through the rotor disk, and the less energy is lost to whirl. This means that high speed operation is more efficient than low speed operation. On the other hand, the blade speed should be as low as possible so that the rotor can be made as simple as possible, with inexpensive fixed blades, and will not fly apart in high winds.

Line 21 of the spreadsheet in FIG. 3 includes a calculation of the C_{U} loss divided by the head drop ΔH. This loss is lowest at the tip (3.6%) and highest at the hub (19.4%). This figure is something that the inventors monitor whilst adjusting the input design parameters (lines 3 to 14 of the spreadsheet). These design parameters are modified until the blade characteristics, including the blade chord, camber angle and stagger angle, meet the requirements.

It can thus be seen that the design process uses actuator disk theory to derive the conditions under which maximum energy can be extracted from the wind. The overall design process is then used to find the lowest efficient speed of operation so that mechanical forces operating on the blades are minimized, thus obviating the use of furling devices for the turbine in high winds.

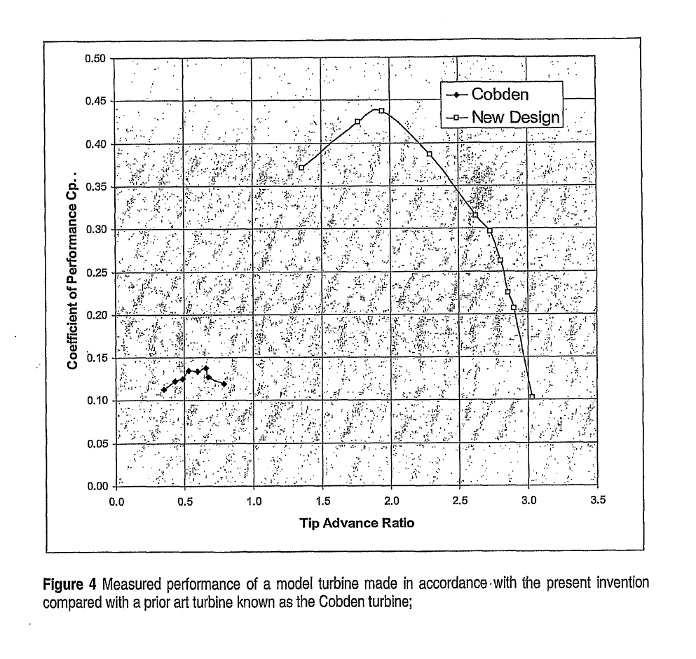

FIG. 4 shows the measured performance of a model 300 mm diameter turbine designed in accordance with the present invention compared to a prior art Cobden turbine. It can be seen that the coefficient of performance (Cp) of the present design has a maximum of about 0.44, which is significantly better than that of the Cobden turbine at about 0.14. It can also be seen that the present design runs faster than the Cobden design, with tip speed ratios of about 2.0 and 0.6 respectively. However, it runs much slower than typical large, high speed wind turbines of the type used in power generation, which operate at a tip speed ratio of about 7.0.

Compared to high speed wind turbines, it can be seen that the turbine produced in accordance with the present invention has broader blades and more of them. For example, the inventors have found that six blades are better then three. Those blades may be formed of sheet metal which is curved and twisted to form the necessary shape, as defined by the calculated values for blade chord, camber angle and stagger angle.

### Manufacture

A turbine designed in accordance with the above described process may be manufactured using conventional fabrication techniques. For example, the cambered plate aerofoil blades may be made using galvanized tin plate which has been roll formed and twisted into the required shape. Similarly, other parts of the turbine rotor may be manufactured using convention techniques. Suitable techniques would be readily apparent to persons skilled in mechanical engineering and need not therefore be explained herein in detail.

### Advantages

The advantages of the preferred form of the design process and the turbine produced in accordance with that process are as follows:
The solid hub traps the air lost through the hub region in other turbines and the energy in the air is extracted by the turbine.
The actuator disk theory component of the design equations enables the blades to be designed to extract the maximum amount of energy from the air.
The combination of the actuator disk theory and cascade theory used in the blade design produces a turbine which operates efficiently at a relatively low speed. This means that the turbine can withstand high wind speeds without rotating so fast that the centrifugal forces on the blades destroy the turbine. This, in turn, means that the mechanical design can be made simpler, avoiding the costly complexity of automatic “furling” or blade tip aerodynamic brakes.

### Alternatives

Whilst a preferred form of the design process, and a turbine manufactured in accordance with that design process, have been described herein, it will be appreciated by persons skilled in the art of wind turbine design that various alterations and modification may be made to the design without departing from the fundamental concepts of the invention. For example, instead of simple aerofoils created by bending flat plate into circular arcs, fully profiled aerofoil-sectioned blades could be used. This would change the form of equation (1) and also equation (16) but would still embody the essence of the inventive design process.

### Nomenclature

| Symbol | Description | Units |
|---|---|---|
| A | Area of turbine normal to airflow = πRₜ² | m² |
| A₁ | constant in lift equation for curved plate aerofoils | deg⁻¹ |
| B₁ | constant in lift equation for curved plate aerofoils | deg⁻¹ |
| c | Chord | m |
| c₁ | Total velocity upstream of the turbine disk | m · s⁻¹ |
| c₂ | Total velocity downstream of the turbine disk | m · s⁻¹ |
| C₁ | constant in lift equation for curved plate aerofoils | — |
| C_{D} | Local coefficient of drag | — |
| C_{Dh} | Coefficient of drag at hub | — |
| C_{Dt} | Coefficient of drag at tip | — |
| C_{L} | Local coefficient of lift | — |
| C_{Lh} | Coefficient of lift at hub | — |
| C_{Lt} | Coefficient of lift at tip | — |
| Cᵤ | Air whirl velocity in direction of blade U velocity | m · s⁻¹ |
| Dₕ | Diameter of rotor at blade hub | m |
| Dₜ | Diameter of rotor at blade tip | m |
| f | Fraction | — |
| Fₕ | Fraction of turbine frontal area blocked by the hub | — |
| g | Gravitational acceleration | 9.8 m · s⁻² |
| i | Incidence of air to blades | degrees |
| iₕ | Angle of incidence at hub | degrees |
| iₜ | Angle of incidence at tip | degrees |
| N | Blade rotational speed | rpm |
| p₁ | Static pressure upstream of the turbine disk | Pa |
| p₂ | Static pressure downstream of the turbine disk | Pa |
| r | Radius | m |
| r_{bc} | radius of blade circular arc | m |
| r_{f} | Radius fraction from hub (0) to tip (1) | — |
| Re | Reynolds number of blade | — |
| Rₕ | Radius of rotor at blade hub | m |
| Rₜ | Radius of rotor at blade tip | m |
| s | Spacing of blades | m |
| S | Solidity = c/s | — |
| U | Blade speed | m · s⁻¹ |
| V_{A} | Axial wind speed far upstream | m · s⁻¹ |
| V_{AD} | Axial wind speed at rotor disk | m · s⁻¹ |
| W | Air velocity relative to the blades | m · s⁻¹ |
| Wₕ | Whirl head lost/Total head drop across turbine | — |
| Wᵣ | Whirl velocity/V_{AD} | — |
| Z | Number of blades | — |
| θ | Camber of circular arc blades | degrees |
| λ | Speed ratio | — |
| λₜ | Tip speed ratio | — |
| β₁ | Angle between upstream air and turbine rotor axis | degrees |
| β₂ | Angle between air leaving turbine and rotor axis | degrees |
| βₘ | Mean air angle | degrees |
| ρ | Air density = 1.21 | kg · m⁻³ |
| ΔH | Total head drop across the turbine disk | m |
| Δp | Static pressure difference across turbine disk | Pa |
| ΔP | Total pressure drop across turbine disk | Pa |
| v | Kinematic viscosity of air = 16 × 10⁻⁶ | m² · s⁻¹ |
| ξ | Stagger angle of blade chord from turbine axis | degrees |

### REFERENCES

Froude, R. E., [1889] Transactions, Institute of Naval Architects, Vol 30: p. 390
Froude, W., [1878] “On the Elementary Relation between Pitch, Slip and Propulsive Efficiency”, Transactions, Institute of Naval Architects, Vol 19: pp. 47-57
Glauert H., [1935] Aerodynamic Theory, W. F. Durand, ed., Berlin: Julius Springer.
Joukowski, N. E., [1918] Travanx du Bureau des Calculs et Essais Aeronautiques de l'Ecole Superiere Technique de Moscou
Rankine, W. J. M., [1865] “On the Mechanical Principles of the Action of Propellers”, Transactions, Institute of Naval Architects, Vol 6: pp. 13-30.
Wilson, Robert E., [1995] Aerodynamic Behaviour of Wind Turbines, chapter 5, Wind Turbine Technology, Spera, David A., ASME Press, New York.

1. A rotor for a horizontal axis wind turbine, the rotor having a hub and a plurality of elongate blades extending radially from the hub, the blades being shaped such that in operation, at any selected radial position along the length of the blades, the ratio of air whirl velocity C_{U} leaving the blades in the direction of blade rotation divided by axial wind speed upstream of the rotor V_{A} is given by:
$$\frac{{C}_{U}}{{V}_{A}} = \frac{4}{9 λ}$$
wherein λ is the local speed ratio at the selected radial position and is given by
$$λ = \frac{U}{{V}_{A}}$$
wherein U is the circumferential blade speed at the selected radial position.

2. A rotor as defined in claim 1 wherein, at the selected radial position, the blade chord c is given by:
c=s×S
wherein
s is the spacing of the blades which is given by
$$s = \frac{2 π r}{Z}$$
wherein r is the radius at the selected radial position and Z is the number of blades
and wherein
S is solidity which is given by:
$$S = \frac{2 cos ( {β}_{m} ) ( {C}_{U} / {V}_{A} )}{( 2 / 3 ) ( {C}_{L} - {C}_{D} tan ( {β}_{m} ) )}$$
wherein
βₘ is a mean angle of air flow relative to the blades and is given by
tan(βₘ)=0.5(tan(β₁)+tan(β₂))
wherein β₁ is an angle between upstream air flowing relative to the blades and the turbine axis of rotation, and is given by
$$tan ( {β}_{1} ) = \frac{λ}{2 / 3}$$
and β₂ is an angle between downstream air flowing relative to the blades and the turbine axis of rotation, and is given by
$$tan ( {β}_{2} ) = \frac{3 ( λ + {C}_{U} / {V}_{A} )}{2}$$
and wherein C_{L} is a coefficient of lift and is given by
C_{L}=C_{Lh}+f×(C_{Lt}−C_{Lh})
and C_{D} is a coefficient of drag and is given by
C_{D}=C_{Dh}+f×(C_{Dt}−C_{Dh})
wherein
C_{Lh} is a selected blade lift coefficient at the hub
C_{Lt} is a selected blade lift coefficient at the blade tips
C_{Dh} is a selected blade drag coefficient at the hub
C_{Dt} is a selected blade drag coefficient at the blade tips
f is a radius fraction at the selected radial position and is equal to 0 at the hub and 1 at the tip of the blade.

3. A rotor as defined in claim 2 wherein each blade is a cambered plate aerofoil and, at the selected radial position, the camber angle θ of the aerofoil is given by:
$$θ = \frac{( {C}_{L} - {A}_{1} \times i - {C}_{1} )}{{B}_{1}}$$
wherein A₁, B₁ and C₁ are constants as follows
A₁=0.0089 deg⁻¹
B₁=0.0191 deg⁻¹
C₁=0.0562
and i is the angle of incidence of air into the blades and is given by
i=iₕ+f×(iₜ−iₕ)
wherein
iₕ is a selected angle of incidence at the blade hub
iₜ is a selected angle of incidence at the blade tip.

4. A rotor as defined in claim 3 wherein, at the selected radial position, the stagger angle ξ, of the blade chord from the axis of rotation of the turbine, is given by:
ξ=β₁+i.

5. A rotor as defined in claim 4 wherein the stagger angle ξ varies from approximately 60 degrees at the hub to approximately 80 degrees at the tip of the blades.

6. A rotor as defined in claim 3 wherein the camber angle θ of the aerofoil varies from 10-15 degrees at the tip of the blades to 25-30 degrees at the hub.

7. A rotor as defined in claim 1 wherein the hub has a diameter of between 40% and 50% of the diameter of the rotor measured at tips of the blades and is solid so as to prevent air passing through the hub.

8. A rotor as defined in claim 5 wherein the hub has a diameter of about 45% of the diameter of the rotor.

9. A horizontal axis wind turbine including a rotor as defined in claim 1.

10. (canceled)

11. A method of defining blade characteristics of a horizontal axis wind turbine, the turbine having a rotor with a hub and a plurality of elongate blades extending radially from the hub, the method including the steps of:
a) selecting a value for at least one of the following design parameters:

| | |
|---|---|
| Number of blades | Z |
| Hub diameter | Dₕ |
| Blade tip diameter | Dₜ |
| Tip Speed ratio | λₜ |
| Far upstream windspeed | V_{A} |

b) selecting a radial position along the length of the blades;
c) computing a local speed ratio λ at the selected radial position based on the selected value(s) of the design parameter(s);
d) computing a ratio of air whirl velocity C_{U} leaving the blades in the direction of blade rotation divided by axial wind speed upstream of the rotor V_{A} using:
$$\frac{{C}_{U}}{{V}_{A}} = \frac{4}{9 λ}$$
e) computing a blade chord, c, camber angle, θ, and stagger angle, ξ, of the blade chord from the turbine axis of rotation, at the selected radial position, as a function of the ratio C_{U}/V_{A}; and
f) selecting at least one alternative radial position and repeating steps (c) to (e) to compute the blade chord, c, camber angle, θ, and stagger angle, ξ, at the alternative radial position in order to define the blade characteristics along the length of the blades.

12. A method as defined in claim 11, further including the step of:
g) selecting an alternative value for at least one of the design parameters and repeating steps (b) to (f) so as to optimise the blade characteristics to maximise energy extraction from the air flow at the lowest rotational speed of the rotor.

13. A method of defining blade characteristics of a horizontal axis wind turbine, the turbine having a rotor with a hub and a plurality of elongate blades extending radially from the hub, the method including the steps of:
a) selecting a value for at least one of the following design parameters:

| | |
|---|---|
| Number of blades | Z |
| Hub diameter | Dₕ |
| Blade tip diameter | Dₜ |
| Tip Speed ratio | λₜ |
| Far upstream windspeed | V_{A} |
| Blade lift coefficient at the blade hub | C_{Lh} |
| Blade lift coefficient at the blade tip | C_{Lt} |
| Blade drag coefficient at the blade hub | C_{Dh} |
| Blade drag coefficient at the blade tip | C_{Dt} |
| Angle of incidence at the blade hub | iₕ |
| Angle of incidence at the blade tip | iₜ |

b) computing the blade rotational speed N based on λₜ, V_{A} and Dₜ
c) computing a radius fraction, f, representing a selected radial position along the length of the blades wherein f equals 0 at the hub and 1 at the blade tip;
d) computing the radius, r, at the selected radial position as a function of f, Dₜ and Dₕ
e) computing the spacing of the blades, s, based on Z
f) computing the blade speed, U, at the selected radial position, based on N
g) computing the local speed ratio, λ, based on U and V_{A}
h) computing a non-dimensional air whirl velocity ratio, C_{U}/V_{A}, leaving the rotor in the direction of blade rotation using
$$\frac{{C}_{U}}{{V}_{A}} = \frac{4}{9 λ}$$
i) computing an angle between upstream air flowing relative to the blade and the turbine axis of rotation, β₁
j) computing an angle between downstream air flowing relative to the blade and the turbine axis of rotation, β₂
k) computing the mean angle of air flow relative to the blade, βₘ, as a function of β₁ and β₂
) computing a coefficient of lift, C_{L}, as a function of f, C_{Lh} and C_{Lt}
m) computing a coefficient of drag, C_{D}, as a function of f, C_{Dh} and C_{Dt}
n) computing the required solidity, S, as a function of βₘ, C_{U}/V_{A}, C_{L} and C_{D}
o) computing the required blade chord, c, based on S and s
p) computing an angle of incidence, i, of the air onto the blades based on f, iₕ and iₜ
q) computing a camber angle, θ, based on C_{L}
r) computing a stagger angle, ξ, of the blade chord from the turbine axis, based on β₁ and i;
s) selecting at least one alternative radial position and repeating steps (c) to (r) to compute the blade chord, c, camber angle, θ, and stagger angle, ξ, at the alternative radial position in order to define the blade characteristics along the length of the blades

14. A method as defined in claim 13, further including the step of:
t) selecting an alternative value for at least one of the design parameters and repeating steps (b) to (s) so as to optimise the blade characteristics to maximise energy extraction from the air flow at the lowest rotational speed of the rotor.

15. A method of defining blade characteristics of a horizontal axis wind turbine, the turbine having a rotor with a hub and a plurality of elongate blades extending radially from the hub, wherein each of the blades is a cambered plate aerofoil having a circular arc cross section, the method including the steps of:
a) selecting a value for at least one of the following design parameters:

| | |
|---|---|
| Number of blades | Z |
| Hub diameter | Dₕ |
| Blade tip diameter | Dₜ |
| Tip Speed ratio | λₜ |
| Far upstream windspeed | V_{A} |
| Blade lift coefficient at the blade hub | C_{Lh} |
| Blade lift coefficient at the blade tip | C_{Lt} |
| Blade drag coefficient at the blade hub | C_{Dh} |
| Blade drag coefficient at the blade tip | C_{Dt} |
| Angle of incidence at the blade hub | iₕ |
| Angle of incidence at the blade tip | iₜ |

b) computing the blade rotational speed N using
$$N = \frac{60 {λ}_{t} {V}_{A}}{π {D}_{t}}$$
c) computing a radius fraction, f, representing a selected radial position along the length of the blades wherein f equals 0 at the hub and 1 at the blade tip;
d) computing the radius, r, at the selected radial position using
r=Rₕ+f×(Rₜ−Rₕ)
wherein
Rₕ is the radius of the rotor at the hub, and
Rₜ is the radius of the rotor at the blade tip;
e) computing the spacing of the blades, s, using
$$s = \frac{2 π r}{Z}$$
f) computing the blade speed, U, at the selected radial position using
$$U = \frac{2 π r N}{60}$$
g) computing the local speed ratio, λ, using
$$λ = \frac{U}{{V}_{A}}$$
h) computing a non-dimensional air whirl velocity ratio, C_{U}/V_{A}, leaving the rotor in the direction of blade rotation using
$$\frac{{C}_{U}}{{V}_{A}} = \frac{4}{9 λ}$$
i) computing an angle between upstream air flowing relative to the blade and the turbine axis of rotation, β₁, from
$$tan ( {β}_{1} ) = \frac{λ}{2 / 3}$$
j) computing an angle between downstream air flowing relative to the blade and the turbine axis of rotation, β₂, from
$$tan ( {β}_{2} ) = \frac{3 ( λ + {C}_{U} / {V}_{A} )}{2}$$
k) computing the mean angle of air flow relative to the blade, βₘ, from
tan(βₘ)=0.5(tan(β₁)+tan(β₂))
l) computing a coefficient of lift, C_{L}, using
C_{L}=C_{Lh}+f×(C_{Lt}−C_{Lh})
m) computing a coefficient of drag, C_{D}, using
C_{D}=C_{Dh}+f×(C_{Dt}−C_{Dh})
n) computing the required solidity, S, from
$$S = \frac{2 cos ( {β}_{m} ) ( {C}_{U} / {V}_{A} )}{( 2 / 3 ) ( {C}_{L} - {C}_{D} tan ( {β}_{m} ) )}$$
o) computing the required blade chord, c, from
c=s×S
p) computing an angle of incidence, i, of the air onto the blades using
i=iₕ+f×(iₜ−iₕ)
q) computing a camber angle, θ, of circular arc blades using
$$θ = \frac{( {C}_{L} - {A}_{1} \times i - {C}_{1} )}{{B}_{1}}$$
wherein A₁, B₁ and C₁ are constants as follows
A₁=0.0089 deg⁻¹
B₁=0.0191 deg⁻¹
C₁=0.0562
r) computing a stagger angle, ξ, of the blade chord from the turbine axis, using
ξ=β₁+i
s) selecting at least one alternative radial position and repeating steps (c) to (r) to compute the blade chord, c, camber angle, θ, and stagger angle, ξ, at the alternative radial position in order to define the blade characteristics along the length of the blades.

16. A method as defined in claim 15, further including the step of:
t) selecting an alternative value for at least one of the design parameters and repeating steps (b) to (s) so as to optimise the blade characteristics to maximise energy extraction from the air flow at the lowest rotational speed of the rotor.

17. A method of manufacturing a rotor for a horizontal axis wind turbine, the rotor having a hub and a plurality of elongate blades extending radially from the hub, the method including the steps of:
defining the blade characteristics in accordance with the method of claim 11; and
manufacturing a rotor including blades with the defined characteristics.

18. A rotor for a horizontal axis wind turbine, the rotor including blades having characteristics defined in accordance with the method of claim 11.

19. A horizontal axis wind turbine including a rotor with a hub and a plurality of elongate blades extending radially from the hub, the blades having characteristics defined in accordance with the method of claim 11.
